(19) United States
(12) Patent Application Publication
(10) Pub. No.: US 2009/0297817 A1
(43) Pub. Date: Dec. 3, 2009

(54) Sealant on polyethylene zipper for polypropylene film substrates

(75) Inventors: Francis Olajide, JR., Bronx, NY (US); David J. Anzini, Middletown, NY (US)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC.

(21) Appl. No.: 12/313,647

(22) Filed: Nov. 21, 2008

Related U.S. Application Data
(60) Provisional application No. 61/057,601, filed on May 30, 2008.

(51) Int. Cl. B32B 7/08; B32B 27/08

(52) U.S. Cl. 428/223; 428/516

(57) ABSTRACT

In the area of manufacture of reclosable packaging, a coextruded layer is provided between the polyethylene zipper and the package walls which are typically a polypropylene substrate. The coextruded layer is an evenly distributed polypropylene/polyethylene mix. Because of the content of polypropylene in coextruded layer, a strong bond is formed with the polypropylene package walls. Likewise, because of the content of polyethylene in coextruded layer, a strong bond is formed with the polyethylene zipper.

This application claims priority under 35 U.S.C. §119(e) from provisional application Ser. No. 61/057,601, filed on May 30, 2008, entitled “Sealant on Polyethylene Zipper for Polypropylene Film Substrates/Polypropylene Zipper for Polypropylene Bag”, the contents of which are hereby incorporated by reference.

### BACKGROUND OF THE INVENTION

1. Field of the Invention

The present invention pertains to the attachment of zippers to film substrates of various compositions and adhesive formulations, in the manufacture of reclosable packages and bags.

2. Description of the Prior Art

In the manufacture of reclosable packages and bags, it is known that sealants on polyethylene base zipper flanges are different types of polyethylene copolymers with low to medium affinity to polypropylene film substrates, thereby resulting in the formation of weak bonds. These weak bonds are the result of high affinity between the polyethylene base resin of the zipper flange and the ethylene-based copolymers used as a sealant.

As has been recognized in the packaging tests disclosed in application Ser. No. 11/728,413, entitled “Hot Melt Adhesive Systems for Zipper Assemblies on Large Bag Constructions of Various Substrates”, filed on Mar. 26, 2007, it is imperative that packaging be designed which can withstand extreme conditions which may occur routinely in the manufacture, shipping, storage, sale and use of consumer products.

### OBJECTS AND SUMMARY OF THE INVENTION

It is therefore an object of the present invention to improve the sealing strength between polyethylene zipper flanges or other zipper components and polypropylene package or bag walls.

This and other objects are attained by provided a coating which adheres or sticks to the polypropylene. The coating is coextruded as a sealant on the zipper flanges. The coating, when heat sealed or glued to the polypropylene film, creates a very strong bond. More specifically, the coextruded sealant provides an even distribution of polypropylene and polyethylene in the zipper sealant layer to ensure excellent bonds across the zipper base material, the coextruded layer and the polypropylene film substrates.

Additionally, embodiments including a polypropylene zipper attached to a polypropylene substrate are disclosed.

### DESCRIPTION OF THE DRAWINGS

Further objects and advantages of the invention will become apparent from the following description and from the accompanying drawings, wherein:

FIG. 1 is a cross-sectional view of a prior art bond between a polyethylene zipper and a polypropylene film substrate layer, such as would be used for reclosable packages or bag.

FIG. 2 is a cross-sectional view of the bond between a polyethylene zipper and a polypropylene substrate, using a first embodiment of the present invention.

FIG. 3 is a cross-sectional view of the bond between a polyethylene zipper and a polypropylene substrate, using a second embodiment of the present invention.

FIG. 4 is a cross-sectional view of a polypropylene zipper heat sealed to a polypropylene substrate.

FIG. 5 is a cross-sectional view of a polypropylene zipper sealed to a polypropylene substrate by way of a coextruded polypropylene sealant and heat sealing.

FIG. 6 is a cross-sectional view of a polypropylene zipper sealed to a polypropylene substrate by way of a coextruded polypropylene sealant and heat sealing, with pressure applied thereto.

### DETAILED DESCRIPTION OF THE PREFERRED EMBODIMENT

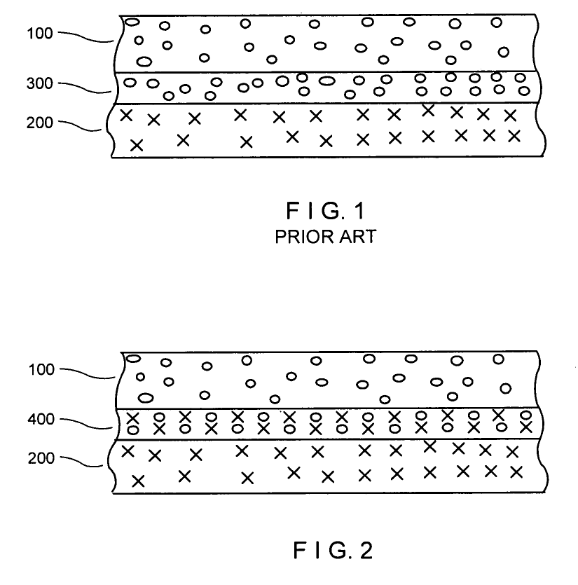

Referring now to the drawings in detail, wherein like numerals refer to like elements throughout the several views, one sees that FIG. 1 is a cross-sectional view of a typical prior art bond between a polyethylene zipper component 100 and a polypropylene substrate 200, from which package or bag walls may be formed. The bond between polyethylene zipper component 100 and polypropylene substrate 200 is formed by a polyethylene coextruded layer 300. The polyethylene coextruded layer 300 forms a relatively strong bond with the polyethylene zipper component 100 due to the similarity in chemical structure of the materials. However, the polyethylene coextruded layer 300 forms a relatively weak bond with the polypropylene substrate 200, due to the difference in the chemical structures of the materials.

FIG. 2, however, is a cross-sectional view of the bond provided by an embodiment of the present invention. A coextruded layer 400 is provided between the polyethylene zipper component 100 (typically, but not limited to, a flange) and the polypropylene substrate 200 (typically, but not limited to, a package or bag wall). The coextruded layer 400 is an evenly distributed polypropylene/polyethylene plastomer mix. Because of the content of polypropylene in coextruded layer 400, a strong bond is formed with the polypropylene substrate 200 (potentially including woven polypropylene). Likewise, because of the content of polyethylene in coextruded layer 400, a strong bond is formed with the polyethylene zipper component 100. The coextruded layer 400 may be first applied to the polyethylene zipper component 100 or to the polypropylene substrate 200.

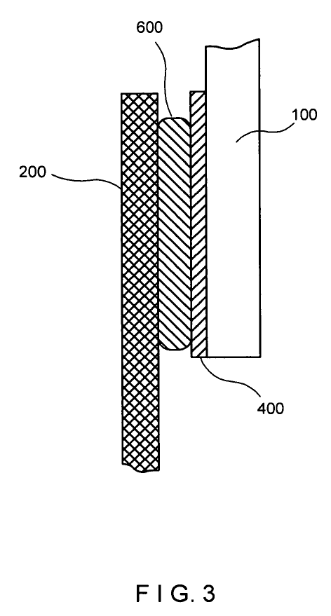

As shown in FIG. 3, coextruded layer 400 may be formed by first extruding a coextruded blend of metallocene polyethylene/polypropylene plastomers onto the polyethylene zipper component 100, then applying a hot melt amorphous polyolefin (APAO) 600 over the coextruded layer 400 on the polyethylene zipper component 100 and finally applying pressure perpendicularly to polyethylene zipper component 100 and polypropylene substrate 200 so as to join polyethylene zipper component 100 and polypropylene substrate 200.

The coextruded blend which forms layer 400 may include a metallocene ethylene-based plastomer homogeneously blended with a low ethylene content propylene plastomer or an ethylene/propylene plastomer resin. The specific plastomers chosen would vary with the application, with a broad range of equivalents being apparent to one of ordinary skill in the art after review of this disclosure.

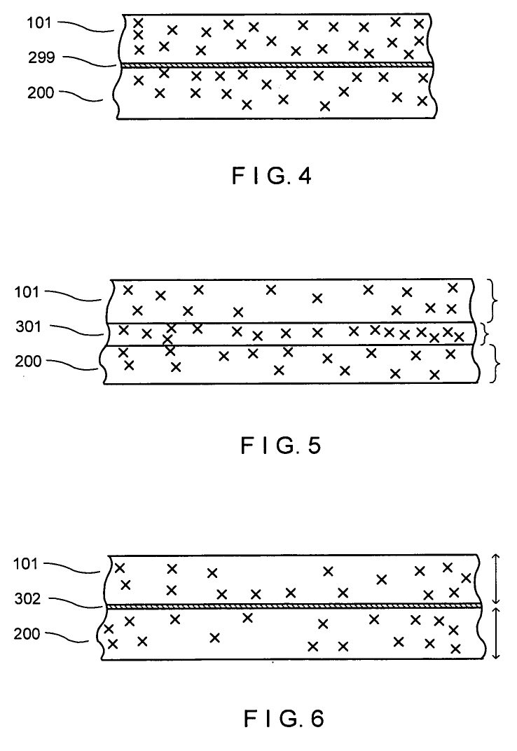

FIGS. 4-6 illustrate an embodiment of the invention wherein a polypropylene zipper (or zipper component) 101 is provided (rather than a polyethylene zipper component 100 as previously described). As shown in FIG. 4, due to the similarity in materials between the polypropylene zipper 101 and the polypropylene substrate 200, a heat seal 299 can be formed directly between the two. Similarly, as shown in FIG. 5, a coextruded layer of polypropylene 301 can join the polypropylene zipper 101 and the polypropylene substrate 200. Moreover, as shown in FIG. 6, a layer of polypropylene adhesive 302, typically accompanied by a subsequent application of pressure, can join the polypropylene zipper 101 and the polypropylene substrate 200.

The results of the embodiments of this invention have been exceptional. For example, without using an embodiment of the present invention, for a polyethylene zipper with a coextruded blend of ethylene based metallocene with an ethylene/propylene copolymer plastomer sealed to various polypropylene substrates, T-peel strengths in the range of 1.6 to 2.1 pounds per inch were typical results. However, by using similar polypropylene substrates, additionally with various APAO hot melt adhesives as described above, T-peel strengths in the range of 14.7 to 15.1 pounds per inch were typical results. Typically, T-peel strengths in the range of at least 7.0 pounds per inch are sought.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A portion of a package including:
a polyethylene zipper component;
a polypropylene substrate; and
a bond between the polyethylene zipper component and the polypropylene substrate including a mixture of a polyethylene plastomer and a polypropylene plastomer.

2. The portion of a package of claim 1 wherein the polyethylene plastomer and the polypropylene plastomer are blended together.

3. The portion of a package of claim 1 wherein the polyethylene plastomer and the polypropylene plastomer are blended together homogenously.

4. The portion of a package of claim 3 wherein the polyethylene plastomer and the polypropylene plastomer are coextruded.

5. The portion of a package of claim 4 wherein the polyethylene plastomer is a resin.

6. The portion of a package of claim 4 wherein the polypropylene plastomer is an ethylene/propylene plastomer resin.

7. The portion of a package of claim 5 wherein the polyethylene resin is a metallocene resin.

8. The portion of a package of claim 6 wherein the polyethylene plastomer is a metallocene ethylene-base plastomer.

9. The portion of a package of claim 4 wherein the bond further includes a layer of amorphous olefin between the polypropylene substrate and mixture of a polyethylene plastomer and polypropylene plastomer.

10. The portion of a package of claim 9 wherein the amorphous olefin is a hot melt amorphous polyolefin.

11. The portion of a package of claim 1 wherein the mixture of a polyethylene plastomer and polypropylene plastomer is extruded onto the polyethylene zipper component.

12. The portion of a package of claim 1 wherein the mixture of a polyethylene plastomer and polypropylene plastomer is extruded onto the a polypropylene substrate.

13. The portion of a package of claim 1 wherein the polypropylene substrate is woven polypropylene.

14. The portion of a package of claim 1 wherein the mixture of a polyethylene plastomer and polypropylene plastomer is chosen to have a strength of at least 7.0 pounds per inch when configured and arranged in the portion of the package.

15. The portion of a package of claim 1 wherein the mixture of a polyethylene plastomer and polypropylene plastomer is chosen to have a strength of at least 7.0 pounds per inch when configured and arranged in the portion of the package.

16. A bonded configuration including:
a polyethylene component;
a polypropylene substrate; and
a bond between the polyethylene component and the polypropylene substrate including a mixture of a polyethylene plastomer and polypropylene plastomer.

17. The bonded configuration of claim 16 wherein the polyethylene plastomer and the polypropylene plastomer are blended together.

18. The bonded configuration of claim 16 wherein the polyethylene plastomer and the polypropylene plastomer are blended together homogenously.

19. The bonded configuration of claim 18 wherein the polyethylene plastomer and the polypropylene plastomer are coextruded.

20. The bonded configuration of claim 19 wherein the polyethylene plastomer is a resin.
